(19) United States
(12) Patent Application Publication
(10) Pub. No.: US 2023/0296188 A1
(43) Pub. Date: Sep. 21, 2023

(54) PIEZO VALVE AND VALVE SYSTEM

(71) Applicant: Festo SE & Co. KG, Esslingen (DE)

(72) Inventors: Martin MAICHL, Salach (DE); Andreas DICKHOFF, Kirchheim unter Teck (DE)

(21) Appl. No.: 18/184,931

(22) Filed: Mar. 16, 2023

(30) Foreign Application Priority Data
Mar. 17, 2022 (DE) 10 2022 106 223.6

(51) Int. Cl. F16K 31/00; F16K 27/00; F16K 11/22

(52) U.S. Cl. CPC F16K 31/005; F16K 27/003; F16K 11/22; F16K 2200/3051

(57) ABSTRACT

A piezo valve for influencing a fluid flow, with a strip-shaped piezo bender which is arranged in a fluid channel and which includes a band-shaped carrier layer and a band-shaped actuator layer applied thereto and which is pressed with a first surface by a spring against a front bearing blade and a rear bearing blade and on a second surface facing away from the first surface with a seal which seals a valve seat in a functional position. The valve seat serves as an orifice opening of a fluid channel section is formed, in which the first surface is formed either by the carrier layer or by the actuator layer and the seal in the first functional position optionally on the valve oil seat or releases the valve seat.

This application claims priority to German application 10 2022 106 223.6, filed Mar. 17, 2022, which is incorporated by reference.

### SUMMARY OF THE INVENTION

The invention relates to a piezo valve for influencing a fluid flow and a valve system with such a piezo valve.

The task of the invention is to provide a piezo valve as well as a valve system with such a piezo valve, which allow a cost-effective adaptation of the valve function to the respective valve task.

This task is solved for a piezo valve of the type mentioned above in that the piezo valve comprises a valve housing which is provided with an input port, an output port and with a fluid channel extending between the input port and the output port, a piezo bending element in the form of a strip being arranged in the fluid channel, which piezo bending element comprises a strip-shaped support layer and a strip-shaped actuator layer applied to support layer, wherein the piezo bending element can be transferred by application of an electrical supply voltage from a first functional position, in which the piezo bending element has a first radius of curvature, into a second functional position, in which the piezo bending element has a second radius of curvature, wherein the piezo bending element is pressed with a first surface by a spring against a front bearing edge and against a rear bearing edge, which are each arranged on an inner surface of the valve housing spaced apart from one another and in a common bearing plane, and wherein the piezo bending element is provided with a seal on a second surface facing away from the first surface, which seal is in sealing contact with a valve seat in one of the functional positions, the valve seat being designed as a mouth opening of a fluid channel section, which fluid channel section is connected to the input port or to the output port, the first surface optionally/alternatively being formed by the support layer or by the actuator layer, and the seal, in the first functional position, optionally/alternatively bearing against the valve seat or exposing the valve seat.

Preferably, it is provided that a positive pressure or a negative pressure is optionally/alternatively applied to the inlet port and that the outlet port is connected to a fluid consumer such as, for example, an actuator. Typically, the fluid channel section extends from the valve seat to the outlet port, but it may also be provided that the fluid channel section extends between the inlet port and the valve seat.

Exemplarily, it is provided that the strip-shaped support layer is formed as a metal sheet which preferably has a rectangular base. A strip-shaped actuator layer is applied to this strip-shaped support layer, which actuator layer can be formed as a ceramic material with piezoelectric properties. Preferably, the actuator layer also has a rectangular cross-section and is formed in the manner of a plane-parallel plate. However, both the geometry of the support layer and of the actuator layer can be formed differently from a rectangular geometry or a plane-parallel plate. For example, the actuator layer is connected to the support layer in such a way that when an electrical supply voltage is applied to the actuator layer and a resulting expansion or contraction of the actuator layer occurs, a change in curvature is induced for the piezo bending element in a plane normal to a largest surface of the strip-shaped support layer and the strip-shaped actuator layer. By way of example, it is provided that the piezo actuator has a first, in particular infinite, radius of curvature in a first functional position, in which no electrical supply voltage is applied to the actuator layer, which means that the piezo actuator is almost even in the first functional position. The piezo actuator is transferred by application of the electrical supply voltage from the first functional position to a second functional position, in which the piezo actuator has a second radius of curvature, which may be smaller than the first radius of curvature.

In a further development of the piezo actuator, a number of strip-shaped actuator layers made of piezoelectric material are applied to a surface of the electrically conductive strip-shaped support layer.

In order to be able to perform the desired valve function, the piezo bending element is pressed with a first surface against a front bearing edge and against a rear bearing edge by a spring, which spring can in particular be a leaf spring made of a spring steel strip material. Due to the interaction between the spring, the piezo bending element and the respective bearing edge, a kind of joint arrangement is formed around which a section of the piezo bending element can be pivoted in the course of its change in curvature by the application of the electrical supply voltage. The front bearing edge and the rear bearing edge are each formed on an inner surface of the valve housing, which inner surface also serves as a boundary surface for the fluid channel, where the front bearing edge and the rear bearing edge are arranged in a common bearing plane. This bearing plane can be described by a first contact line, which is defined by the front bearing edge touching the surface of the piezo bending element and by a second contact line, which is defines by the rear bearing edge touching the first surface of the piezo bending element.

On a second surface facing away from the first surface and preferably aligned parallel to the first surface, the piezo bending element is provided with a seal. This seal can, for example, be a plane-parallel plate made of a rubber-elastic material. Alternatively, the seal can also have a three-dimensional geometry that differs from that of a plane-parallel plate. The seal is intended to be in sealing contact with a valve seat either in the first functional position of the piezo actuator or in the second functional position of the piezo actuator. Due to the sealing contact between the seal and the valve seat a fluidically communicating connection between the input port and the output port is interrupted. The valve seat is designed as a mouth opening of a fluid channel section which is connected to the input port or to the output port. Preferably, the mouth opening is designed as a preferably circular-cylindrical bore in an inner surface of the valve housing, so that the valve seat can be defined, for example, as an annular surface.

In order to be able to ensure advantageous adaptation of the piezo valve to different valve requirements, it is envisaged that the piezo bending element can be placed either with the support layer or with the actuator layer against the front bearing edge and the rear bearing edge, and the seal is attached to the actuator layer or to the support layer depending on the spatial orientation of the piezo bending element. Furthermore, a further influence on the valve function of the piezo valve can be taken by the fact that the seal in the first functional position either abuts the valve seat or clears the valve seat.

Advantageous further embodiments of the invention are the subject of the subclaims.

It is expedient if the spring is designed as a leaf spring and rests on the piezo bending element with a front end region located opposite to the front bearing edge and with a rear end region located opposite to the rear bearing edge and wherein the spring is supported in a central section on a bearing surface of the valve housing.

It is advantageous if the front bearing edge is formed on a metal plate and/or if the rear bearing edge is formed on a metal plate, the metal plate being supported or fixed on an inner surface of the valve housing and a recess being formed in the valve housing in the region of the metal plate, in particular in the region of the respective bearing edge, for geometrical adaptation, in particular for laser adjustment, of a geometry of the respective metal plate. It is preferably provided that geometry of the metal plate can be changed, in particular adjusted, in its geometry by a force application or a contactless adjustment process, in particular by local heating by means of a laser beam, in order to bring about a change in position for the respective bearing cutting edge. This change in position, which is in particular a change in the distance of the respective bearing edge from the valve housing, can on the one hand compensate for manufacturing tolerances so that the desired sealing effect between the seal of the piezo bending element and the valve seat can actually be achieved in the respective functional position in which the seal is meant to be in sealing contact with the valve seat. In addition, it is possible to adapt the sealing force acting on the valve seat when the seal is in sealing contact to the desired effective pressure direction for the piezo valve. The effective pressure direction describes whether, in the case of sealing contact of the seal on the valve seat, the retained fluid pressure is aligned in an opening direction for the piezo valve or in a closing direction for the piezo valve. Accordingly, an advantageous preload for the piezo bending element can be effected by the geometrical adaptation of the metal plate and the positional displacement of the respective bearing edge.

Accordingly, in an advantageous further development of the invention, it can be provided that the geometry of the metal plate is adapted to a pressure effective direction of a fluid pressure acting on the seal, when the seal is in the sealing position with respect to the valve seat.

Preferably, it is provided that an electrical contact arrangement is formed at an end region of the piezo bending element facing away from the seal, which electrical contact arrangement passes through a wall section of the valve housing and is sealingly connected to the wall section. The electrical contact arrangement enables the electrical supply voltage to be supplied to the piezoelectric actuator, the electrical contacts of the contact arrangement being sealingly accommodated in the wall section of the valve housing and are accessible from outside the valve housing.

In an advantageous further development of the invention, it is provided that the first radius of curvature and the second radius of curvature point in a common radius direction, which radius direction is arranged in a plane of curvature oriented transversely to the first surface and/or to the second surface. Accordingly, it is assumed that the piezo bending element is to be transferred between a weaker curved configuration to a more curved configuration by applying the electrical supply voltage. In particular, it may be provided that the first radius of curvature approaches infinity, which is the case when the first surface and/or the second surface of the piezoelectric beamer are at least almost flat in the first functional position. Alternatively, an increase in a radius of curvature can also be provided when the supply voltage is applied.

Preferably, it is provided that the piezoelectric bender, the spring, the front bearing edge, the rear bearing edge, the valve seat and the fluid channel section form a valve assembly and that a first valve assembly and a second valve assembly are arranged in the valve housing, each comprising the aforementioned components of valve assembly. Preferably, the first valve assembly, which is formed as a valve assembly, and the second valve assembly, which is also formed as a valve assembly, are arranged in a common fluid chamber from which the fluid channel section of the first valve assembly and the fluid channel section of the second valve assembly extend, this fluid chamber together with the two fluid channel sections forming the fluid channel in the valve housing. In such a design of the piezo valve, it can be provided that the fluid chamber is supplied with pressurized fluid by providing an overpressure at the input port and that a supply of the pressurized fluid is made possible by selective control of the piezo bending element of the first valve assembly or the piezo bending element of the second valve assembly at the respective output port of the first valve assembly or the second valve assembly. Optionally or as a matter of choice the piezo actuator of the first valve assembly and the piezo actuator of the second valve assembly can be supplied individually with an electrical supply voltage or a common electrical supply for both piezo actuators can be provided. Alternatively, a vacuum or underpressure supply of the fluid chamber can be provided, so that a vacuum or underpressure supply at the respective outlet ports is also possible.

In a further embodiment of the invention, it is provided that the second valve assembly is arranged mirror-symmetrically to the first valve assembly and that a mirror plane is oriented transversely to a distance between the opposing front bearing edges and/or transversely to a distance between the opposing rear bearing edges. This makes it possible to realize a particularly compact design for the piezo valve.

It is advantageous if the valve seat and the fluid channel section of the first valve assembly and the valve seat and the fluid channel section of the second valve assembly are formed in a nozzle carrier which is accommodated in the valve housing in a sealing manner, the input port or output port provided on the nozzle carrier for the first valve assembly and the input port or output port provided on the nozzle carrier for the second valve assembly being formed on the nozzle carrier outside the valve housing. The separate design of the nozzle carrier, which can be sealingly installed on the valve housing, allows selection for the characteristics of the fluid channel section for the first valve assembly and for the fluid channel section of the second valve assembly. For example, the piezo valve can be equipped with different nozzle carriers in the manner of a modular system to ensure advantageous adaptation of the piezo valve to different types of valve requirements. It is also possible to arrange the piezo bending elements in the valve housing in such a way that the piezo bending elements, which are mirror images of each other, can be curved in either the same or opposite directions when supplied with electrical energy.

In one embodiment of the piezo valve, the piezo bending element of the first valve assembly closes the valve seat of the first valve assembly in the first functional position and the piezo bending element of the second valve assembly closes the valve seat of the second valve assembly in the first functional position. This results in a combination of two normally closed output ports. This can be used, for example, to supply two fluid consumers individually with overpressure or underpressure in the respective second functional positions of the piezo actuator or to supply a single fluid consumer with double the fluid flow by cascading the output of first and second valve assemblies.

In an alternative embodiment of the piezo valve, it is provided that the piezo bending element of the first valve assembly closes the valve seat of the first valve assembly in the first functional position and that the piezo bending element of the second valve assembly releases the valve seat of the second valve assembly in the first functional position. This results in a combination of a normally closed output port and a normally open output port.

In a further alternative embodiment of the piezo valve, it is provided that the piezo bending element of the first valve assembly in the first functional position releases the valve seat of the first valve assembly and that the piezo bending element of the second valve assembly in the first functional position releases the valve seat of the second valve assembly. This results in a combination of two normally open output ports. This allows, for example, to supply two fluid consumers individually with overpressure or underpressure in the respective first functional positions of the piezo actuators, or to supply a single fluid consumer with twice the fluid flow by cascaded control of the first and second valve assemblies in the first functional positions.

In a further embodiment of the invention, the valve housing is provided with or is provided with a nozzle carrier having first matching, in particular identical, cross-sections for the fluid channel sections of the first and second valve assemblies, which has second matching, in particular identical, cross-sections for the fluid channel sections of the first and second valve assemblies or is provided with a nozzle carrier which has a first cross-section for the fluid channel section of the first valve assembly and a second cross-section for the fluid channel section of the second valve assembly, and in that the first cross-section is smaller than the second cross-section. Hereby, an adaptation of the respective cross-section for the fluid channel section of the first and the second valve assembly can be made according to the requirements for the use of the piezo valve. Preferably, the nozzle carrier is formed as a separate component.

The task of the invention is solved by a valve system with a piezo valve according to the invention, which comprises a control device which provides an electrical control voltage to the piezo actuator as a function of an arrangement of the piezo actuator in the valve housing and as a function of a flow direction of a fluid flowing around the piezo actuator.

### BRIEF DESCRIPTION OF THE DRAWINGS

Advantageous embodiments of the invention are shown in the drawing. Here shows:

FIG. 1 a purely schematic sectional view of a first embodiment of a piezo valve, which is equipped with two valve assemblies arranged mirror-inverted to each other, wherein the piezo bending elements of the two valve assemblies are configured in such a way that a normally closed valve position is present,

FIG. 2 a schematic side view of the piezo valve according to FIG. 1,

FIG. 3 a schematic top view of the lower piezo bending element from the piezo valve of FIG. 1 with the two bearing edges, and

FIG. 4 a purely schematic sectional view of a second embodiment of a piezo valve, in which the piezo bending elements of the two valve assemblies are configured in such a way that a normally open valve position is present, whereby a control device, shown only schematically, is assigned to the piezo valve in order to form a valve system.

### DETAILED DESCRIPTION OF THE INVENTION

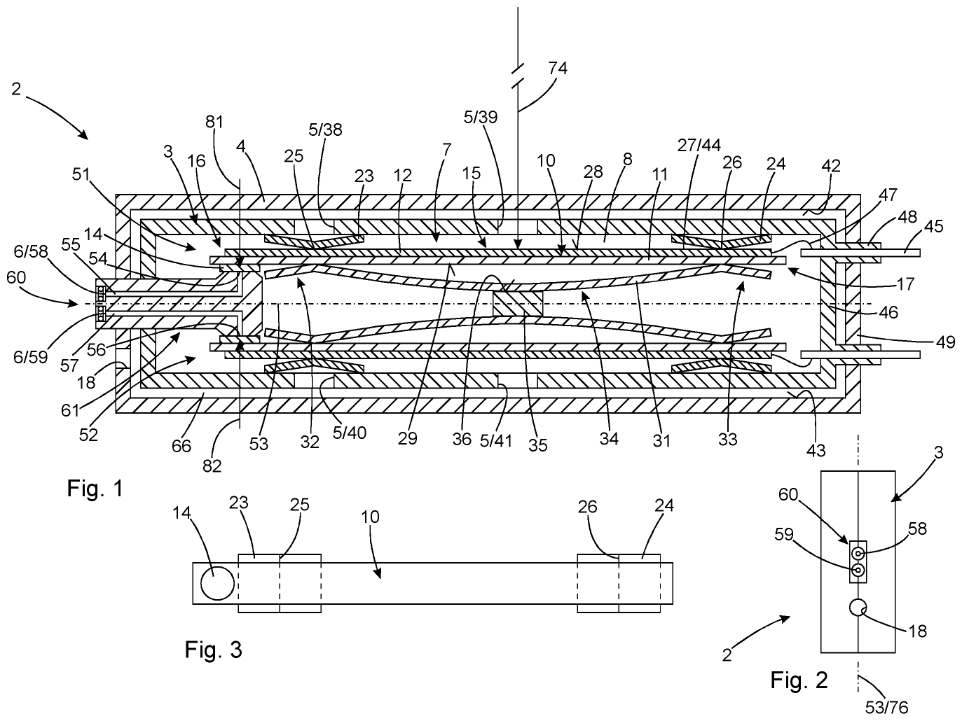

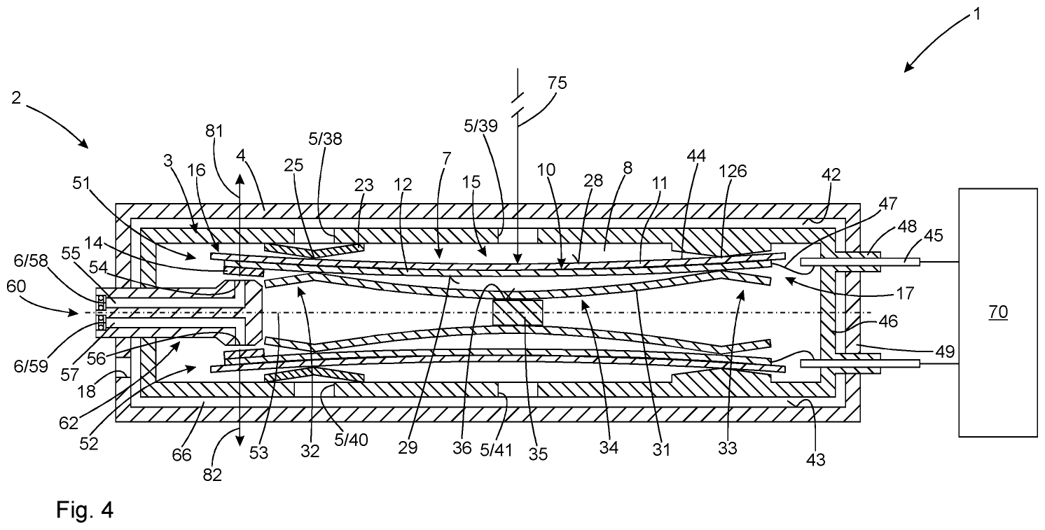

The embodiments of a piezo valve 2 shown in FIGS. 1 and 4 differ only in the installation position of the piezo bending element 10 described in more detail below and an adjustment adapted thereto, so that the following description of the embodiment according to FIG. 1 also applies to the embodiment according to FIG. 4, and with regard to the embodiment of FIG. 4 only the present differences are discussed. The same reference numbers are used for both embodiments.

The piezo valve 2 comprises a purely exemplary cuboid valve housing 3, in which the components of the piezo valve 2 described in more detail below are accommodated and which is surrounded purely exemplarily by an outer shell 4. The outer shell 4 forms a pressure chamber for the piezo valve 2, so that the piezo valve 2 can be operated in the standalone position. In deviation from the representation of FIG. 1, the piezo valve 2 may be accommodated in one of several shafts of a valve carrier, in which case the respective shaft together with the valve housing 3 delimits the pressure space required for the function of the piezo valve 2. By way of example, it is provided that the valve housing 3 according to FIG. 1 is formed from two mirror-symmetrically aligned, identical housing shells.

According to the representation of FIG. 1, the piezo valve 2 comprises a first valve assembly 51 and a second valve assembly 52, which are arranged mirror-symmetrically to a mirror plane 53 and each comprise identical components. The mirror plane 53 is oriented transversely to the plane of representation of FIG. 2. The following description of the first valve assembly 51 applies in the same way to the second valve assembly 52, so that for reasons of clarity only the components of the first valve assembly 51 are provided with reference numbers in the representation of FIG. 1 and a description of the components of the second valve assembly 52 is omitted.

The first valve assembly 51 comprises a strip-shaped piezo bending element 10, which is formed purely exemplarily from a support layer 11 and an actuator layer 12 applied thereto. For example, the support layer 11 is a sheet metal strip in the form of a plane-parallel plate to which the actuator layer 12, formed from a ceramic coating with piezoelectric properties, is applied by material bonding.

In an alternative embodiment of a piezo bending element, a multilayer structure of ceramic coatings with piezoelectric properties can also be realized, preferably without the metallic support layer.

According to the embodiments shown in FIGS. 1 to 4, the actuator layer 12 is configured in such a way that it undergoes contraction or shortening along a longest edge 44 when an electrical supply voltage is applied, as a result of which the piezoelectric actuator 10 is transferred from the first functional position shown in FIG. 2 to a second functional position. However, since the support layer 11 does not undergo a change in length due to the applied supply voltage, there is a change in curvature for the piezo bending element 10 analogous to a bimetallic strip. Exemplarily, a curvature of the piezo bending element 10 that disappears in the first functional position, which can be described with an at least substantially infinite first radius of curvature 74 shown only symbolically, changes to a curvature with a second radius of curvature 75 shown only symbolically, which is smaller than the first radius of curvature. For the first valve assembly 51, this means that, starting from the first functional position as shown in FIG. 1, the piezo bending element 10 is deflected downward in a central region 15 in the second functional position, while a front end region as well as a rear end region 17 of the piezo bending element 10 are deflected upward.

As can be seen from the representation of FIG. 1, the first radius of curvature 74 and the second radius of curvature 75 point in the same spatial direction and are also arranged in a common plane of curvature corresponding to the plane of representation of FIG. 1.

In order to enable utilization of the change in curvature of the piezoelectric bender 10 for a valve function, it is provided that the piezoelectric bender 10 is arranged with a first surface 28 formed by the actuator layer 12 facing an inner surface, referred to as the upper inner surface 42, of the valve housing 3, while a second surface 29 of the piezoelectric bender 10 formed by the support layer 11 faces away from the upper inner surface 42. It is further provided that the piezo bending element 10 is pressed against a front bearing edge and a rear bearing edge 26 by means of a spring 31, which may be a leaf spring of strip-shaped design made of a spring-elastic material, in particular spring steel. Preferably, the front bearing edge 25 and the rear bearing edge 26 are arranged in a common bearing plane 27. It is particularly preferred that the bearing plane 27 is congruent with the first surface 28 of the respective piezo bending element 10.

Purely exemplarily, it is provided that the front bearing edge 25 is formed as a buckling edge of a front metal plate 23 and that the rear bearing edge 26 is formed as a buckling edge of a rear metal plate 24. Both the front metal plate 23 and the rear metal plate 24 are connected to the inner surface 42 of the valve housing 3 in a manner not shown in more detail or are at least fixedly received there. Alternatively, it can be provided that a rear bearing edge 126 is integrally formed on the valve housing 3 and is thus formed, in particular, from the same plastic material as the valve housing, as shown purely exemplarily in FIG. 4.

The spring 31 has a front end region 32 formed purely exemplarily with a bend facing the piezo bending element 10 and a rear end region 33 formed in the same way and is curved in an arc shape in a central section 34. In order to ensure a permanent force transmission from the spring 31 via the front end region 32 and the rear end region 33 to the piezo bending element 10 and from there to the front bearing edge 25 and the rear bearing edge 26, 126, it is provided that the spring rests with the middle section 34 on a bearing surface 36 of a projection 35 of the valve housing 3. Further, the spring 31 is mounted with a preload in the valve housing 3.

The piezo bending element 10 is provided at the rear end portion 17 in a purely exemplary manner with a flexible connecting lead 47, which in turn is electrically connected to a pin-shaped contact arrangement 45. It is provided that the contact arrangement 45 passes through a wall section 46 of the valve housing 3 and is sealingly accommodated in a contact sleeve 48 integrally formed on the wall section 46, the contact sleeve 48 in turn passing sealingly through a rear wall section 49 of the outer casing 4 and extends to an outside of the valve housing 3. The contact arrangement 45 thus enables, in cooperation with the flexible connection line 47, a provision of an electrical supply voltage to the piezoelectric transducer 10. Deviating from the illustration according to FIG. 1, it may be provided that the wall section 46 is formed as a separate component and is sealingly incorporated into the valve housing 3 and/or the outer shell 4.

The piezo bending element 10 is provided with a seal 14, which can also be named as a sealing pad, at the front-end region 16, which is attached to a second surface 29 of the piezo bending element 10. Purely exemplarily, this second surface 29 is determined by the support layer 11, while the first surface 28 is determined by the actuator layer 12. Opposite the seal 14, a valve seat 54 formed as a mouth opening of a fluid channel section 55 is provided in a nozzle carrier 61, wherein the valve seat 54 and the fluid channel section 55 belong to the first valve assembly 51. Furthermore, the nozzle carrier 61 is provided with a valve seat 56 formed as an orifice of a fluid channel section 57, which is associated with the second valve assembly 52.

Alternatively, for the embodiment according to FIG. 1, the nozzle carrier 62 shown in the embodiment of FIG. 4 described in more detail below can be used, in which the fluid channel sections 55 and 57 have an enlarged cross-section compared to the nozzle carrier 61. Alternatively, the nozzle carrier 61 shown in FIG. 1 can be used for the embodiment according to FIG. 4.

By way of example, it is provided that the nozzle carrier 61 passes through both the valve housing 3 and the outer casing 4 and is accommodated in the outer casing 4 in a purely exemplary sealing manner. The outer casing 4 is additionally provided with a recess 18, which can also be referred to as an inlet port 5. Thus, the outer shell 4 delimits a pressure chamber 66 in which the piezo valve 2, also referred to as a valve cartridge, is accommodated. For example, the recess 18 can be used to connect a fluid hose, which is not shown, to a fluid source, which is also not shown, so that the pressure chamber 66 can be permanently pressurized. Since the valve housing 3 is not sealed with respect to the pressure chamber 66 and is penetrated, purely by way of example, by a total of four recesses 38, 39, 40, 41, a fluid duct 7 defined by the valve housing 3 is in fluidic communication with the pressure chamber 66, at least in sections, and has the same fluid pressure as the pressure chamber 66. The fluid channel 7 comprises a purely exemplary cuboid fluid chamber 8. The fluid chamber 8 is essentially bounded by the inner surfaces of the valve housing, which are aligned at right angles to one another and are of purely exemplary flat design. By way of example, it is provided that the recesses 38 and 39 penetrate the valve housing 3 starting from an upper inner surface 42 which is aligned horizontally according to the representation of FIG. 1, and that the recesses 40 and 41 penetrate the valve housing 3 starting from a lower inner surface 43 which is aligned horizontally according to the representation of FIG. 1 and which is also an inner surface of the valve housing 3. In fluidic terms, the recesses 38 to 41 can each be viewed as input ports 5 for the piezo valve 2.

The fluid channel 7 bounded by the valve housing 3 thus extends from the recesses 38 to into the fluid chamber 8 and from there through the fluid channel section 55 for the first valve assembly 51 and through the fluid channel section 57 for the second valve assembly 52. The fluid channel sections 55, 57 each open out outside the valve housing 3 and the outer shell 4 at outlet openings 58, 59, as can also be seen from the illustration in FIG. 2. These outlet openings 58, 59 are also referred to as outlet connections 6. By way of example, it is provided that a fluid coupling can be coupled to the connection piece 60 of the nozzle carrier 61, which projects beyond the valve housing 3 and the outer casing 4, and which is designed for the pneumatic connection between the respective fluid channel sections 55, 57 and pneumatic consumers.

An orifice of the fluid channel section 55 of the first valve assembly 51 facing the fluid chamber 8 is also referred to as a valve seat 54 for the first valve assembly 51. An orifice of the fluid chamber section 57 of the second valve assembly 52 facing the fluid chamber 8 is also referred to as a valve seat 56 for the second valve assembly 52.

In order to be able to realize a valve function, it is provided that the piezo bending element arranged between the upper inner surface 42 and the nozzle carrier 61 abuts with its seal in a sealing manner against the valve seat 54 for the first valve assembly 51 in a neutral position, in which no electrical supply voltage is provided to the piezo bending element 10, and thus blocks a fluidically communicating connection between the fluid chamber 8 and the outlet opening 58. Thus, the first valve assembly 51 forms a normally closed valve which can be transferred from the first functional position shown in FIG. 1 to a second functional position by providing a suitable electrical supply voltage. In the second functional position, the seal 14 is lifted from the valve seat 54 for the first valve assembly 51 and there is a fluidic communicating connection between the fluid chamber 8 and the outlet opening 58.

In order to realize this relative movement of the seal 14 with respect to the valve seat 54 for the first valve assembly 51, the piezoelectric actuator 10 is configured in such a way that, when the electrical supply voltage is applied, it can be transferred from the first functional position as shown in FIG. 1 to a curved position in which a distance between the front end region 16 and the rear end region 17 of the piezoelectric actuator 10 with respect to the upper inner surface 42 is reduced. Further, in this second functional position, which is not shown, a distance of the middle portion 15 of the piezoelectric bender 10 with respect to the upper inner surface 42 is increased. Here, the situation arises that a first radius of curvature 74 approaching infinity in the first functional position is transformed into a second radius of curvature 75 which is considerably smaller than the first radius of curvature 74, as is shown for the piezoelectric beamer installed in the opposite direction according to FIG. 4. It must be taken into account here that the support layer 11 and the actuator layer 12 are completely flat only in the ideal case, which results in the first radius of curvature 74 approaching infinity. In practice, it can be assumed that even in the first functional position there is a first radius of curvature 74 which is larger than the second radius of curvature by a factor of 100 to 10.000 larger than the second radius of curvature 75.

Purely by way of example, it is provided that in pressure chamber 66 and thus also in fluid chamber 8 there is an overpressure relative to the two outlet openings 58, 59, so that the seals 14 of the two piezo beaters 10 are each pressed onto the associated valve seat 54 and respectively as a result of this pressure difference. This circumstance is symbolized by the effective pressure direction 81, 82 shown only symbolically in FIG. 1 for each valve assembly 51, 52. If it should be known during the assembly of the piezo valve 2 in which way this piezo valve 2 will be used, an adjustment of a position of the front bearing edge can be provided in a contact-bound or preferably a contactless procedure, in particular by a local heating of the front metal plate 23 with a laser beam. In this adjustment process, it is intended to set a distance between the front bearing edge 25 for the first valve assembly 51 and the upper inner surface 42 or, respectively, a distance between the front bearing edge 25 for the second valve assembly 52 and the lower inner surface 43 in such a way that an advantageous valve function is ensured.

If, on the other hand, it is envisaged that the piezo valve is to be used as a normally open valve in deviation from the embodiment of FIG. 1, it can be envisaged, as shown in FIG. 4, to arrange both the piezo bending element 10 for the first valve assembly 51 and the piezo bending element 10 for the second valve assembly 52 in the valve housing 3 in such a way that the first surface 28 is formed in each case by the support layer 11 and the second surface 29 is formed in each case by the actuator layer 12. Furthermore, it can be provided in this context that the respective piezo bending element 10 is preformed in such a way that in the first functional position, in which no electrical supply voltage is applied to the piezo bending element 10, it is curved in such a way that the seal 14 does not rest on the respective valve seat 54, 56. This results in the radius of curvature 75 shown, which in the embodiment of the figure is drawn as the radius of curvature for the first functional position.

In the first functional position, a fluidic communicating connection between the pressure chamber 66, the fluid chamber 8 and the two outlet openings 58 and 59 is ensured. Purely by way of example, the piezo valve 2 shown in FIG. 4 is used to control negative pressure, so that the two pressure directions 81, 82 are also drawn in the opposite direction to the design shown in FIG. 1.

When the supply voltage is applied, the respective piezo bending element 10 is then transferred, in deviation from the embodiment according to FIG. 1, from a curved first functional position with the radius of curvature 75 into an at least largely flat second functional position, in order to ensure a sealing support of the seal 14 on the respective valve seat 54, in the second functional position, and in this case can assume the radius of curvature 74 as shown in FIG. 1.

Also for such a configuration of the piezo bending element 10, an adjustment of the position of the respective front bearing edge 25 can be provided by a contact deformation or a contactless deformation of the front metal plate 23.

In addition, a control device 70 is shown in FIG. 4, which provides the electrical supply voltages for the two piezo actuators 10 of the piezo valve 2. Preferably, it is provided that the control device 70 is parameterized depending on a configuration of the piezo actuators 10, i.e. optionally the confirmation according to FIG. 1 or the configuration according to FIG. 4, in order to ensure an advantageous electrical control of the respective piezo actuators 10. The control device 70 can be used in the same way for the embodiment of the piezo valve 2 shown in FIG. 1.

In an embodiment of a piezo valve, one of the two piezo bending elements is designed and mounted for a normally closed valve function, while the other of the two piezo bending elements is designed and mounted for a normally open valve function.

Crucially, each of the two piezo actuators 10 can be installed in the valve housing 3 in an individual spatial orientation, i.e., with either the support layer 11 or the actuator layer 12 facing the respective nearest inner surface 42, 43, in order to achieve the desired normally open or normally closed valve function. Furthermore, an individual adjustment of the position of the front bearing edge 25 is provided in each case depending on the installation position of the respective piezo bending element 10. The adjustment is carried out alternatively or in addition to the dependence on the installation position of the respective piezo actuator 10 in dependence on the planned direction of pressure action for the respective valve assembly 51, 52.

1. A piezo valve for influencing a fluid flow, comprising a valve housing having an input port and an output port and a fluid channel extending between the input port and the output port, wherein a piezoelectric bending element in the form of a strip is arranged in the fluid channel, which piezoelectric bending element comprises a strip-shaped support layer and a strip-shaped actuator layer applied to the strip-shaped support layer, wherein the piezo bending element can be transferred by application of an electrical supply voltage from a first functional position, in which the piezo bending element has a first radius of curvature, into a second functional position, in which the piezo bending element has a second radius of curvature, wherein the piezo bending element is pressed with a first surface by a spring against a front bearing edge and against a rear bearing edge, which first and second bearing edges are each arranged on an inner surface of the valve housing at a distance from one another and are located in a common bearing plane, and wherein the piezo bending element is provided on a second surface facing away from the first surface with a seal which, in one of the first functional and the second functional position, is in a sealing abutment against a valve seat, wherein the valve seat is formed as a mouth opening of a fluid channel section connected to the input port or to the output port, wherein the first surface is formed either by the support layer or by the actuator layer.

2. The piezo valve according to claim 1, wherein the spring is a leaf spring and bears against the piezo bending element with a front end region located opposite the front bearing edge and with a rear end region located opposite the rear bearing edge, and wherein the spring is supported in a central section on a bearing surface of the valve housing.

3. The piezo valve according to claim 1, wherein the front bearing edge is formed on a metal plate and/or wherein the rear bearing edge is formed on a metal plate, the metal plate being fixed to an inner surface of the valve housing, and a recess being formed in the valve housing in the region of the metal plate for a geometric adaptation of a geometry of the respective metal plate.

4. The piezo valve according to claim 3, wherein the geometry of the metal plate is adapted to a pressure direction of a fluid pressure acting on the seal.

5. The piezo valve according to claim 1, wherein an electrical contact arrangement is formed at an end region of the piezo bending element facing away from the seal, which electrical contact arrangement passes through a wall section of the valve housing and is connected to the wall section in a sealing manner.

6. The piezo valve according to claim 1, wherein the first radius of curvature and the second radius of curvature point in a common radius direction, which is arranged in a plane of curvature aligned transversely to the first surface and/or to the second surface.

7. The piezo valve according to claim 1, wherein the piezo bending element, the spring, the front bearing edge, the rear bearing edge, the valve seat and the fluid channel section form a valve assembly, and wherein a first valve assembly comprising said valve assembly and a second valve assembly comprising said valve assembly are arranged in the valve housing.

8. The piezo valve according to claim 7, wherein the second valve assembly is arranged mirror-symmetrically to the first valve assembly and wherein a mirror plane is aligned transversely to a distance between the opposing front bearing edges and/or transversely to a distance between the opposing rear bearing edges.

9. The piezo valve according to claim 7, wherein a nozzle carrier which is sealingly received in the valve housing comprises the valve seat and the fluid channel section of the first valve assembly and the valve seat and the fluid channel section of the second valve assembly and wherein the input port or output port provided on the nozzle carrier for the first valve assembly and the input port or output port provided on the nozzle carrier for the second valve assembly are formed outside the valve housing on the nozzle carrier.

10. The piezo valve according to claim 7, wherein the piezo bending element of the first valve assembly closes the valve seat of the first valve assembly in the first functional position and wherein the piezo bending element of the second valve assembly closes the valve seat of the second valve assembly in the first functional position.

11. The piezo valve according to claim 7, wherein the piezo bending element of the first valve assembly closes the valve seat of the first valve assembly in the first functional position and wherein the piezo bending element of the second valve assembly releases the valve seat of the second valve assembly in the first functional position.

12. The piezo valve according to claim 7, wherein the piezo bending element of the first valve assembly in the first functional position releases the valve seat of the first valve assembly and wherein the piezo bending element of the second valve assembly in the first functional position releases the valve seat of the second valve assembly.

13. The piezo valve according to claim 7, wherein the valve housing is provided with a nozzle carrier which has first cross sections for the fluid channel sections of the first and second valve assemblies or wherein the valve housing is provided with a nozzle carrier which has second cross sections for the fluid channel sections of the first and second valve assemblies of the first and second valve assemblies or wherein the valve housing is provided with a nozzle carrier having a first cross-section for the fluid channel portion of the first valve assembly and a second cross-section for the fluid channel portion of the second valve assembly, and wherein the first cross-section is formed smaller than the second cross-section.

14. A valve system with a piezo valve, the piezo valve comprising a valve housing having an input port and an output port and a fluid channel extending between the input port and the output port, wherein a piezoelectric bending element in the form of a strip is arranged in the fluid channel, which piezoelectric bending element comprises a strip-shaped support layer and a strip-shaped actuator layer applied to the strip-shaped support layer, wherein the piezo bending element can be transferred by application of an electrical supply voltage from a first functional position, in which the piezo bending element has a first radius of curvature, into a second functional position, in which the piezo bending element has a second radius of curvature, wherein the piezo bending element is pressed with a first surface by a spring against a front bearing edge and against a rear bearing edge, which are each arranged on an inner surface of the valve housing at a distance from one another and in a common bearing plane, and wherein the piezo bending element is provided on a second surface facing away from the first surface with a seal which, in one of the functional positions, is in a sealing abutment against a valve seat, wherein the valve seat is formed as a mouth opening of a fluid channel section connected to the input port or to the output port, wherein the first surface is formed either by the support layer or by the actuator layer and with a control device which provides an electrical control voltage to the piezo bending element in dependence on an arrangement of the piezo bending element in the valve housing and in dependence on a flow direction of a fluid flowing around the piezo bending element.
